(19) United States
(12) Patent Application Publication
(10) Pub. No.: US 2014/0092035 A1
(43) Pub. Date: Apr. 3, 2014

(54) SYSTEM AND METHOD FOR CONTROLLING DEVICE SWITCHING ON/OFF, AND MOBILE COMMUNICATION DEVICE THEREFOR

(71) Applicant: POWERTECH INDUSTRIAL CO., LTD., NEW TAIPEI CITY (TW)

(72) Inventor: CHIEN- HSIN SU, NEW TAIPEI CITY (TW)

(73) Assignee: POWERTECH INDUSTRIAL CO., LTD., NEW TAIPEI CITY (TW)

(21) Appl. No.: 13/803,855

(22) Filed: Mar. 14, 2013

(30) Foreign Application Priority Data
Sep. 28, 2012 (TW) 101135773

(51) Int. Cl. G06F 3/041

(52) U.S. Cl. CPC G06F 3/0412
USPC 345/173

(57) ABSTRACT

A system for controlling device switching on/off including an electronic device and a mobile communication device is illustrated. The mobile communication device includes a haptic display unit and a processing unit. The haptic display unit displays a setting page having a clock pattern and a set of timer indexes. The set of timer indexes includes a switch-on index and a switch-off index locating on the fringe of the clock pattern and indicating to a start time and a stop time respectively. The switch-on and switch-off indexes slide around the fringe of the clock pattern to determine the start and stop time according to touch gestures of a user. The start time and stop time change based on the location of the indexes. The processing unit configures the electronic device to be switched on and off based on the start and stop time, accordingly.

### BACKGROUND

1. Technical Field

The present disclosure relates to a system and a method for controlling device switching on/off, in particular, to a system and a method for controlling device switching on/off using a mobile communication device.

2. Description of Related Art

Most of the timing controllers adapted for electronic device are mechanical rotating-disc apparatuses and have to be physically connected between the plug of the electronic device and the power socket. So that the on/off switching operations of the electronic device can be configured using multiple contacts of the timing controllers. In use, not only that it is necessary to provide the timing controller, the operation of the timing controller must be manually configured including manually calibrating the current time setting and manually adjusting the positions of the contacts. Additionally, whenever the timing controller has been removed from the power socket, for the timing controller to switch on/off the electronic device at correct timing, the current time setting has to be recalibrated.

Moreover, even though the mobile communication device can enable the users to perform various operations and configurations on the user interface provided, however the operational procedure is quite complex. Specifically, during the configuration, users in practice often would be directed into new layer or entering new page along with selections made on the user interface and returning to the main page sequentially through layers visited after completion. And after completion of the configuration, users have to verify whether the date configured is accurate by selecting and entering the corresponding verification page causing inconvenience for users.

### SUMMARY

An exemplary embodiment of the present disclosure provides a system for controlling device switching on/off including at least an electronic device and a mobile communication device. The mobile communication device includes a haptic display unit and a processing unit. The haptic display unit is used for displaying a setting page. The setting page has a clock pattern and at least a set of timer indexes, wherein the set of timer indexes further includes a switch-on index and a switch-off index. The switch-on index and the switch-off index located on the fringe of the clock pattern indicating a start time and a stop time, respectively. The switch-on index and the switch-off index slide around the fringe of the clock pattern according to the touch gestures of a user to determine the start time and stop time. The start time and the stop time vary along with positions of the switch-on index and the switch-off index. The processing unit is used for switching on the electronic device based on the start time and switching off the electronic device based on the stop time.

An exemplary embodiment of the present disclosure provides a method for controlling device switching on/off which is used for configuring on/off operation of an electronic using a mobile communication device. The method includes the following steps. A setting page on a haptic display unit of the mobile communication device is provided, wherein the setting page has a clock pattern and at least a set of timer indexes. The set of timer indexes including a switch-on index and a switch-off index with the switch-on index and the switch-off index located on the fringe of the clock pattern indicating a start time and a stop time, respectively. The switch-on index and switch-off index slides in response to the touch gestures of a user to determine the start time and stop time. The start time and the stop time vary along with positions of the switch-on index and the switch-off index. The electronic device is switched on in response to the start time determined and is switched off the electronic device in response to the stop time determined.

An exemplary embodiment of the present disclosure provides a mobile communication device used for the system and the method of controlling device switching on/off.

To sum up, an exemplary embodiment of the present disclosure provides a system and a method for controlling device switching on/off, and a mobile communication device therefor which allow a user to complete a timing setup through a setting page thereby eliminating the operational inconvenience of hierarchical user interface. Additionally, the present disclosure enables the user to directly configure the timing setting using touch gestures on a haptic display unit provided such that the user can perform operation by intuitively looking at the pattern displayed on the haptic display unit thereby increase the ease of use.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram illustrating a portable electronic device in accordance to an exemplary embodiment of the present disclosure.

FIG. 2 is a diagram illustrating the mobile communication device and the electronic device being controlled thereby in accordance to an exemplary embodiment of the present disclosure.

FIG. 3 is a block diagram illustrating another system for controlling device switching on/off provided in accordance to an exemplary embodiment of the present disclosure.

FIG. 4 is a diagram illustration another system for controlling device switching on/off provided in accordance to an exemplary embodiment of the present disclosure.

FIG. 5 is a flow chart diagram illustrating a method for controlling device switching on/off provided in accordance to an exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

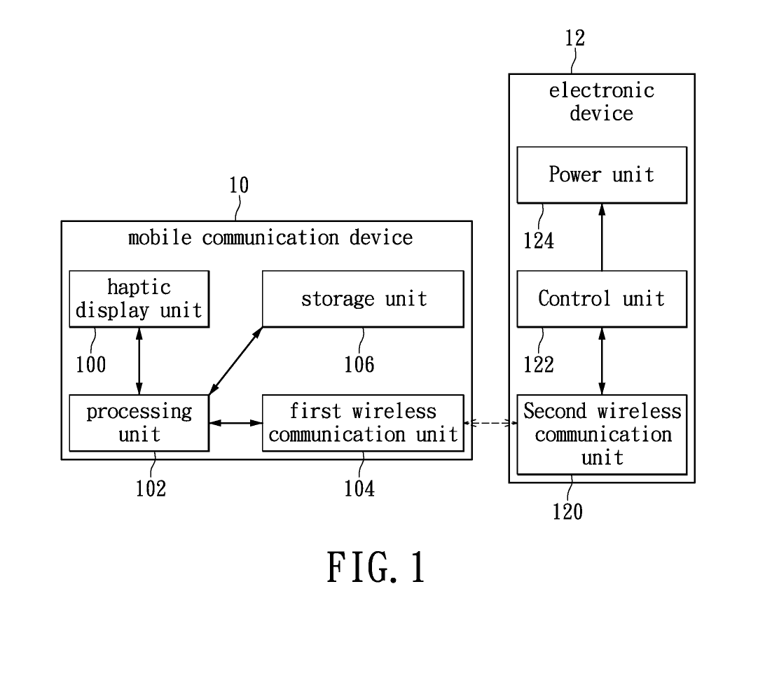

Please refer to FIG. 1, which shows a block diagram illustrating a system for controlling device switching on/off provided in accordance to an exemplary embodiment of the present disclosure. A system 1 for controlling device switching on/off includes a mobile communication device 10 and at least an electronic device 12. The mobile communication device 10 at least includes a haptic display unit 100 and a processing unit 102.

The haptic display unit 100 of the mobile communication unit 10 is coupled to the processing unit 102. The haptic display unit 100 is used for receiving the touch gesture inputs of a user and outputting the corresponding input instruction to the processing unit 102. The processing unit 102 further controls the haptic display unit 100 to display data.

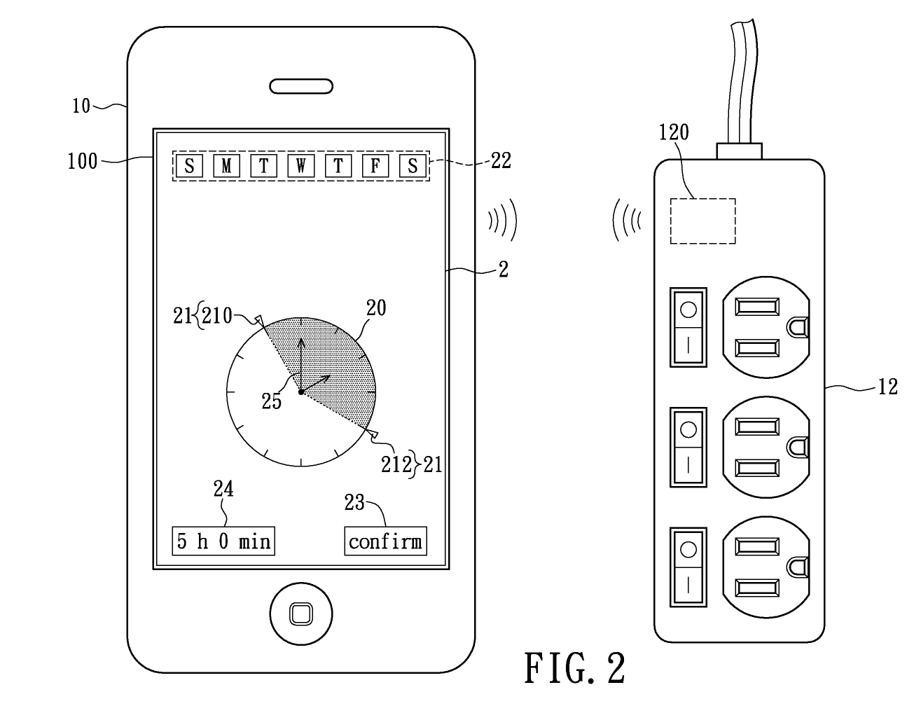

Please refer to FIG. 2 at same time, which shows a diagram illustrating the mobile communication device and the electronic device being controlled thereby in accordance to the exemplary embodiment of the present disclosure. The mobile communication device 10 may include but not limited to a smart phone having the haptic display unit 100 and a tablet having communication functionality. The haptic display unit 100 can display a setting page 2 generated by a timer application program for controlling on/off switching operations of the electronic device 12. In one embodiment, the electronic device 12 may be a power outlet having a plurality of receptacles installed.

The setting page 2 displayed on the haptic display unit 100 can have a clock pattern 20 and at least a set of timer indexes 21. The clock pattern 20 has a plurality of time marks disposed circumferentially representing 12-hour clock or 24-hour clock. The shape of the clock pattern 20 in the instant embodiment may take form of commonly seeing analog clock including but not limited to a disc-shape as shown in FIG. 2, a ellipse-shape, and polygon-shape. The set of timer indexes 21 includes a switch-on index 210 and a switch-off index 212. The switch-on index 210 and the switch-off index 212 located on the fringe of the clock pattern 20 respectively point to the time marks. The switch-on index 210 corresponds to a start time, i.e., the time in corresponding to the time mark which the switch-on index 210 pointed to. The switch-off index 212 corresponds to a stop time, i.e., the time in corresponding to the time mark which the switch-off index 212 pointed to.

Since the setting page 2 is displayed on the haptic display unit 100, the user therefore can directly manipulate the switch-on index 210 and the switch-off index 212 on the haptic display unit 100 via sliding operation to specify the start time and stop time, respectively. The switch-on index 210 and the switch-off index 212 can slide along the fringe of the clock pattern 20 pointing at different time on the dial according to the touch gesture performed by the user on the haptic display unit 100. The start time and the stop time respectively vary along with the positions of the switch-on index 210 and the switch-off index 212.

When the user decide the start time and the stop time according to switch-on index 210 and switch-off index 212, respectively, the processing unit 102 can control the electronic device 12 to switch on at the start time and switch off at the stop time according to the start time and the stop time determined. For instance, the user can click the confirm icon 23 on the setting page 2 to verify the start time and the stop time decided after slide operation of the switch-on index 210 and switch-off index 212 of the same set of timer indexes 21. For user to easily identify the time segment of formed by the start time and the stop time, the processing unit 102 can control the clock pattern 20 to shade the fan-shaped region formed by the center point of the clock pattern 20, the start time and the stop time as depicted in FIG. 2.

Please refer back to FIG. 1, the mobile communication device 10 may include a first wireless communication unit 104, and the electronic device 12 may include a second wireless communication device 120 corresponding to the first wireless communication unit 104, a control unit 122 and the power unit 124. The first wireless communication unit 104 and the second wireless communication unit 120 may be a Bluetooth unit, infrared unit or wireless network unit (e.g., WiFi). The first wireless communication unit 104 is connected to the processing unit 102. The mobile communication device 10 and the electronic device 12 may be wirelessly connected through the first wireless communication unit 104 and the second wireless communication unit 120.

When the start time has arrived, the processing unit 102 can generate and wirelessly transmit the switch-on signal to the electronic device 12 through the first wireless communion unit 104. The second wireless communication unit 120 can receive and output the switch-on signal to the control unit 122. The control unit 122 can be designed to drive the power unit 124 to fully power or partially power the electronic device 12 upon receiving the switch-on signal. For example, cutting off the power provided to one or more receptacles. Similarly, when the stop time has arrived, the processing unit 102 can generate and transmit the switch-off signal to have the control unit 122 of the electronic device 12 controlling the power unit 124 to partially or completely cut off the power provided to the electronic device 12.

Please refer to FIG. 2 again. The setting page 2 of the instant embodiment not only can be used for configuring the start time and the stop time, but also can include a date/periodicity configuration area 22 provided for user to control the electronic device 12 on a single-day event or multiple-day event. The date/periodicity configuration area 22 can display date or periodicity pattern for user to select one or more days using touch gestures on the haptic display unit 100. The date or the periodicity as depicted in FIG. 2 may be days in a week, e.g., Monday to Friday. After the date or the periodicity of the date/periodicity configuration area 22 has been selected, the user may click the confirm icon 23 for verification. The processing unit 102 thus can control the on/off switching operations of the electronic device 12 according to the start time and the stop time on the selected date.

In the instant embodiment, after the start time and the stop time has been determined, the processing unit 102 can calculate the time interval between the start time and the stop time and display on the time display area 24 of the setting page 2 (e.g., 5 h 0 min shown in FIG. 2), accordingly. The user can thereby easily obtain the switch-on duration of the electronic device 12.

Additionally, as shown in FIG. 2, the time index 25 can be disposed inside the clock pattern 20 relative to the position of the timer index 21 point the time marks. The time index 25 may be the hour hand and the minute hand collectively indicating the current time. Such that the user may configure the start time the stop time according to the current time displayed.

Refer back to FIG. 1, the mobile communication device 10 may further include a storage unit 106 which is coupled to the processing unit 102, and store data associated with the timer application program for the processing unit 102 to access and execute. The processing unit 102 can display the setting page 2 on the haptic display unit 100 by executing the data. The storage unit 106 can further store the start time and the stop time determined, the date or periodicity selected. The controlled electronic device 12 of FIG. 2 is only for illustration, in practice the controlled electronic device 12 can include but not limited to the power switch, television, lamp, computer, heater, stereo, or electronic lock.

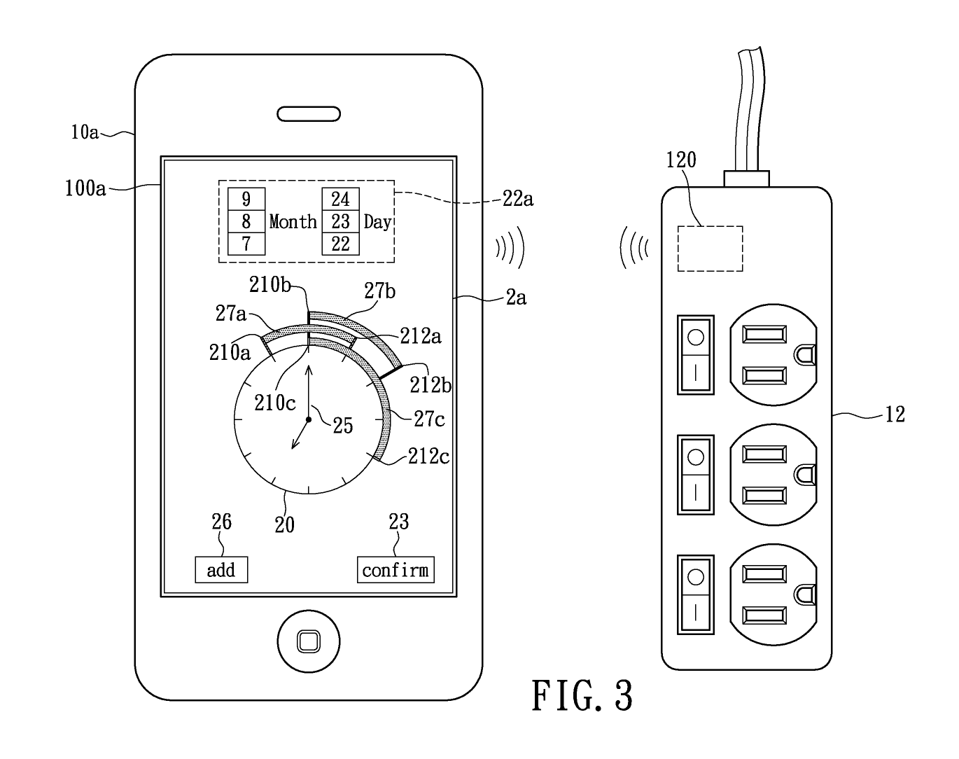

Please refer to FIG. 3 in conjunction with FIG. 1, wherein FIG. 3 shows a block diagram illustrating another system for controlling device switching on/off provided in accordance to an exemplary embodiment of the present disclosure. The haptic display unit 100a of the mobile communication device 10a displays another setting page 2a. Please refer to the previous embodiment for descriptions over the clock pattern 20 and the confirm icon 23.

The difference between the instant embodiment and the embodiment of FIG. 2 is that the setting page 2a may enable the user to configure multiple sets of the timer index to decide multiple start times and stop times. The setting page 2a further display the information for the start times and stop times. FIG. 3 uses three timer indexes for illustrations. Each timer index herein correspondingly includes a switch-on index and a switch-off index, respectively indicated by three sets of timer indexes 210a and 212a, 210b and 212b as well as 210c and 212c.

For the ease of identification, the time intervals determined by each set of timer indexes located at fringe of the clock pattern 20 are color-coded in the instant embodiment. Taking the switch-on index 210a and the switch-off index 212a as an example, the processing unit 102 (referring to FIG. 1) not only determines that the user has configured the start time to be 11 o'clock and the stop time to be 1 o'clock via sliding around the fringe of the clock pattern 20, the processing unit 102 can also color-coded the time segment between the switch-on index 210a and the switch-off index 212a with a color block 27a. Accordingly, the use can quickly see the two-hour duration by referencing the switch-on index 210a, the switch-off index 212a, and the color block 27a. Similarly, the time segment formed between the start time and the stop time being determined by the switch-on index 210b and the switch-off index 212b may be represented by a color block 27b having color differ from the color block 27b. On the same ground, the time segment formed between the switch-on index 210c and the switch-off index 212c can be represented by the color block 27c, accordingly. Such that the user can easily obtain the start time, the stop time, and the duration associated with the plurality sets of switching time even if the setting page 2a has no time display area.

The time segments between the start time and the stop time determined by the plurality sets of timer indexes may be partially or completely overlapped. In particular, all three sets of the timer indexes of FIG. 3 overlap the time segment from 12 o'clock to 1 o'clock and two of the timer indexes overlap the time segment from 1 o'clock to 2 o'clock. As such, in order to prevent the color blocks become undistinguishable as result of overlapping color block, when time segments of any two timer indexes become partially or completely overlap with each other, the processing unit 102 configures the switch-on index, the switch-of index, and the color blocks corresponding to one set of the timer index to extending from outer side of the clock pattern 20 to staggerly arrange the color blocks. Specifically, as shown in FIG. 3, color block 27b and 27c respectively extend outwardly to avoid the time segments between 12 o'clock to 1 o'clock and 1 o'clock to 2 o'clock overlapped. Additionally, the sets of timer indexes, the associated start time and the stop time, and the associated time intervals can be clearly displayed.

The setting page 2a of the instant embodiment further includes adding new pattern 26. When a set of start time and stop time has been determined, the user can touch the adding new pattern 26 to add a new set of timer indexes. The processing unit 102 may display another set of switch-on and switch-off indexes around the fringe of the clock pattern according to the touch gesture of the user. Accordingly, the user can through slide the switch-on index and switch-off index deciding new start time and stop time.

For the ease of identifying different sets of timer indexes, the switch-on index and the switch-off index associated with each set of timer indexes can be shown with different color, e.g., set the color of switch-on and switch-off indexes to the color of corresponding color block.

Moreover, the date or periodicity displayed in the date/periodicity configuration area may be the month and data selection menu shown in FIG. 3 provided user to select a specific data while configuring the start and stop times of a set of timer indexes. The selection is further stored in the storage unit after being confirmed. The processing unit 102 may control the on/off switching operation according to the start time and the stop time determined on the selected date.

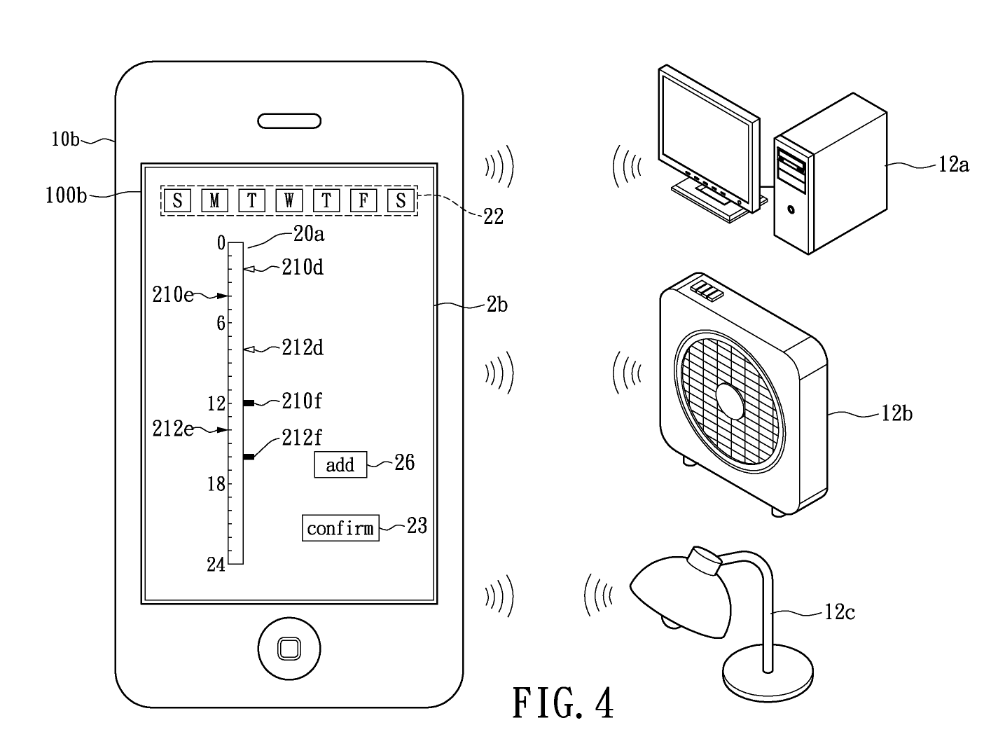

Please refer to FIG. 4 in conjunction to FIG. 1, in which FIG. 4 shows a diagram illustration another system for controlling device switching on/off provided in accordance to an exemplary embodiment of the present disclosure. The haptic display unit 100b of the mobile communication device 10b shown in FIG. 4 has a setting page 2b. The difference between the setting page 2b from the setting page 2a is that the setting page 2b has a bar-shape clock pattern 20a representing time axis for configuring start and stop times. The bar-shape clock pattern 20a may be designed in vertical fashion or horizontal fashion. FIG. 4 illustrates the bar-shape clock pattern 20a in the vertical fashion.

The instant embodiment illustrates three sets of timer indexes, e.g., timer indexes 210d and 212d, timer indexes 210e and 212e, and timer indexes 210f and 212f with each timer indexes includes a switch-on index and a switch-off index. The three sets of timer indexes located at fringe of the clock pattern 20a can determine the corresponding start time and stop time according to the touch gesture of the user on the time axis. For user to be able to identify different sets of timer indexes, the processing unit 102 can display the plurality sets of timer indexes on two sides of the clock pattern 20a and color code the timer indexes with different color.

As shown in FIG. 3 and FIG. 4, the setting page 2a (or 2b) may be used to configure multiple sets of timer indexes to determine the corresponding sets of start time and stop time. The plurality sets of start time and stop time can be used to control multiple switching on/off operations of an electronic device as well as respectively or simultaneously control multiple electronic devices e.g., computer 12a, fan 12b, and lamp 12c. The start time and the stop time determined for each timer indexes and the selected date can be stored in the storage unit 106 (shown in FIG. 1). Additionally, the electronic devices 12a˜12c includes a second wireless transmission unit corresponds to the first wireless transmission unit, respectively. The electronic devices 12a˜12c respectively has an identification data which is stored in the storage unit 106 when the first wireless transmission unit 104 connects to the second wireless transmission unit. The identification data may for instance be a device name or model associated with electronic devices 12a˜12c. Please refer to FIG. 1, the processing unit 102 may relate the identification data to the start time and stop time associated with at least a set of timer indexes. As such, the plurality sets of start time and stop time determined by the plurality of timer indexes can be used to control multiple electronic devices 12. When the processing unit 102 controls the switching on/off operations of the electronic device 12 according to one of the plurality sets of start time and stop time, the processing unit 102 can identify one of the electronic device 12 to be controlled according to the corresponding identification data stored in the storage unit 106. The processing unit 102 can further generate and transmit a switch-on signal or a switch-off signal containing identification data associated with the electronic device 12 to the electronic device 12 has identical identification data so as to switch on/off the electronic device 12.

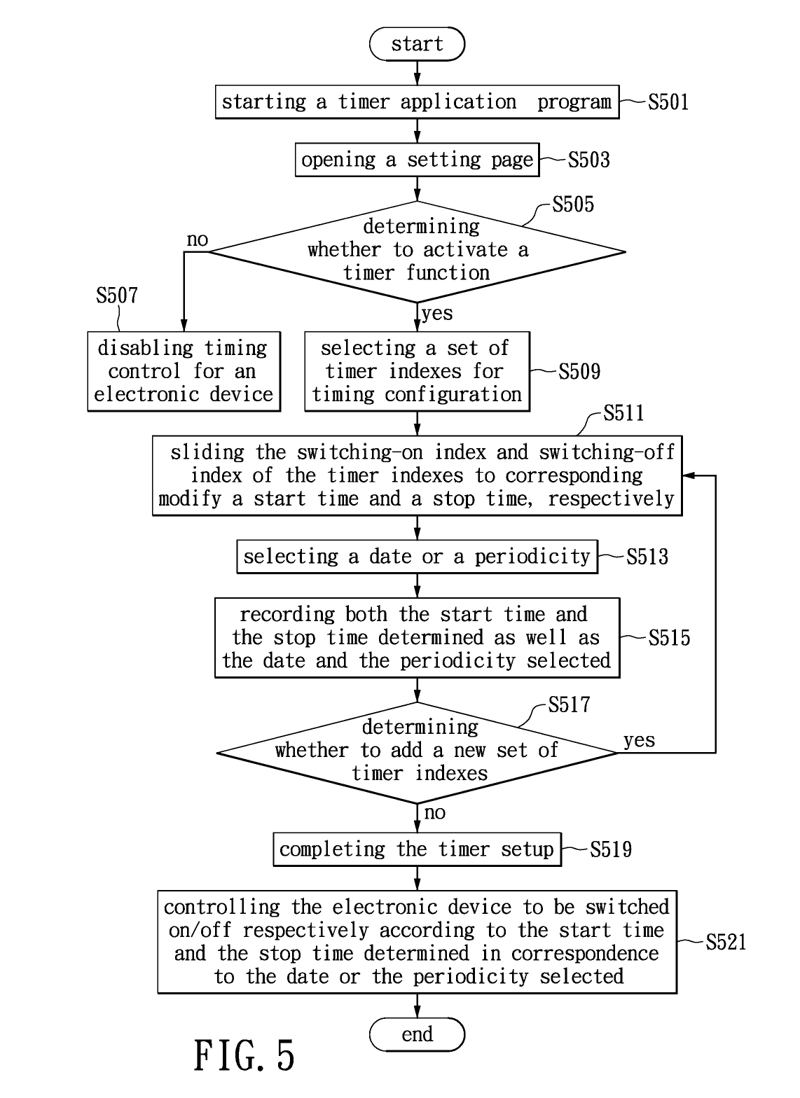

Please refer to FIG. 5, which shows a flow chart diagram illustrating a method for controlling device switching on/off provided in accordance to an exemplary embodiment of the present disclosure. The method can be implemented using the system for controlling device switching on/off.

The processing unit 102 can starts a timer application program for according to the touch gestures of user on the haptic display unit 100 of the mobile communication device 10. (Step S501). The processing unit 102 starts and displays a setting page on the haptic display unit 100 according to the operation of the user. (Step S503) The setting page may include an activation menu for selecting whether to activate the timer function. (Step S505). When not using the timer function, the processing unit 102 does not need to timing control the on/off switching operation of the electronic device 12.

When determined to activate the timer function, selects a set of timer indexes on the setting page to configure a start time and a stop time, respectively. (Step S509) The setting page includes a clock pattern. The timer indexes include a switch-on index and a switch-off index, respectively located at fringe of the clock pattern indicating the corresponding start time and the stop time. The switch-on index and the switch-off index change the corresponding start time and stop time by being sliding around the fringe of the clock pattern according to touch gestures of the user on the haptic display unit 100. (Step S511). A date or periodicity from the date/periodicity configuration area on the setting page is selected to have the processing unit 102 controlling the on/off switching operations of the electronics device 12 according to the start time and the stop time determined on the selected date. The processing unit 102 can record and store the information of the start time, the stop time, and the date in the storage unit 106 after user has completed configurations for one set of timer indexes. (Step S515)

The processing unit 102 further can determine whether the user has selected the adding new pattern on the setting page to add new set of timer indexes via touch gestures. (Step S517) If the processing unit 102 determines adding new set of timer index, the processing unit 102 can execute the steps after Step S511 to have the switch-on index and the switch-off index slide according the touch gestures of the user to determine new set of start time and stop time, accordingly. (Step S511)

Conversely, if the processing unit 102 determines that no new set of timer indexes is being added, the processing unit 102 determines that the on/off switching operation configurations of the electronic device 12 has been completed. (Step S519). Under the activation of the timer function, the processing unit 102 respectively transmits the switch-on signal and the switch-off signal wirelessly to switch on or switch off the electronic device 12 according to the start time and the stop time determined on the selected date or periodicity. (Step S521).

The above control method is merely an implementation for configuring the mobile communication device and controlling the operations of electronic device described in the aforementioned embodiment. In practice, steps may be skipped or exchanged in other embodiments, e.g., the Step 513 of selecting date or periodicity can be exchanged with Step S511. Or the Step 513 may be eliminated and configuring the electronic device to switch on/off daily according to the start time and the stop time. Similarly, the Step S515 of adding new timer indexes is not a necessary step, hence may be eliminated as well.

The aforementioned system and method for controlling device switching on/off, and mobile communication device may enable user intuitively deciding the switch on/off timings of an electronic device according to an exemplary embodiment provided for the present disclosure. User can deciding the time by sliding related timer indexes around the clock pattern on a single setting page instead of flipping page or going to various application program pages to perform the configuration.

Additionally, as described by each embodiment, the timer indexes for indicating the start time and the stop time are located around the fringe of the clock pattern being used to display time marks. So that the user can directly configure the timing setting using touch gestures on a haptic display unit to select the desire time and can instantly observe the positioning movement of the timer indexes and the corresponding time.

The present disclosure further provides various methods for user to easily identify the time intervals between the start time and the stop time determined. As such, users can easily identify multiple set of time segments configured.

Moreover, the system, method, and device can through a wireless communication unit wirelessly switch on/off the electronic device at the start time and the stop time configured.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A mobile communication device capable of controlling device switching on/off, for switching on/off at least an electronic device having wireless communication functionality, the mobile communication device comprising:
a haptic display unit, displaying a setting page, the setting page having a clock pattern and at least a set of timer indexes, the set of timer indexes including a switch-on index and a switch-off index, the switch-on index and the switch-off index located on the fringe of the clock pattern indicating a start time and a stop time, respectively, wherein the switch-on index and the switch-off index slide around the fringe of the clock pattern according to the touch gestures of a user to determine the start time and the stop time, wherein the start time and the stop time vary along with positions of the switch-on index and the switch-off index; and
a processing unit, switching on the electronic device based on the start time, and switching off the electronic device based on the stop time.

2. The mobile communication device according to claim 1, further comprising:
a first wireless communication unit, coupled to the processing unit, and wirelessly connected to the electronic device;
wherein the processing unit respectively generates a switch-on signal and a switch-off signal based on the start time and the stop time, the first wireless communication unit transmitting the switch-on signal and the switch-off signal to the electronic device to switch on/off the electronic device.

3. The mobile communication device according to claim 1, wherein the shape of the clock pattern is of a disc, a polygon, or a strip.

4. The mobile communication device according to claim 1, wherein the setting page further comprises a date/periodicity configuration area, provided for the user to select at least a date or a periodicity, the processing unit configuring the on/off switching operations of the electronic device based on the start time and the stop time determined on the date or the periodicity selected.

5. The mobile communication device according to claim 1, wherein the setting page further comprises a time display area, displaying a time interval between the start time and the stop time calculated by the processing unit.

6. The mobile communication device according to claim 1, wherein the time segment between the switch-on index and the switch-off index on the clock pattern is shown in different color than the other time segments on the clock pattern.

7. The mobile communication device according to claim 1, wherein the setting page further comprises a time index located inside the clock pattern, the time index indicating the current time.

8. The mobile communication device according to claim 1, wherein multiple sets of the timer indexes are located around the clock pattern, the time segment between the start time and the stop time of each set of the timer indexes are highlighted with different colored blocks, wherein when at least a portion of the time segments of at least two sets of the timer indexes overlaps, extends at least one set of the overlapped timer indexes and the corresponding color block outwardly from the clock pattern.

9. The mobile communication device according to claim 1, wherein multiple sets of the timer indexes are highlighted with different colors and are respectively used to control on/off switching operations of one or more electronic device.

10. The mobile communication device according to claim 9, further comprising:
a storage unit, coupled to the processing unit, storing the start time and the stop time of each set of timer indexes, and an identification data used by the timer indexes for controlling the electronic device, whereby each set of timer indexes is related to the identification data of one electronic device;
wherein the processing unit connects to the corresponding electronic device through the first wireless communication unit according to the identification data.

11. A system for controlling device switching on/off, comprising:
at least an electronic device; and
a mobile communication device, comprising:
a haptic display unit, displaying a setting page, the setting page having a clock pattern and at least a set of timer indexes, the set of timer indexes includes a switch-on index and a switch-off index, the switch-on index and the switch-off index located on the fringe of the clock pattern indicating a start time and a stop time, respectively, wherein the switch-on index and the switch-off index slide around the fringe of the clock pattern according to the touch gestures of a user to determine the start time and stop time, wherein the start time and the stop time vary along with positions of the switch-on index and the switch-off index; and
a processing unit, switching on the electronic device based on the start time and switching off the electronic device based on the stop time.

12. The system according to claim 11, wherein the mobile communication device comprises a first wireless communication unit, the electronic device comprises a second wireless communication unit, wherein the processing unit generates a switch-on signal and a switch-off signal based on the start time and the stop time, and transmits the switch-on signal and the switch-off signal through the first wireless communication unit to the second wireless communication unit to switch on/off the electronic device.

13. The system according to claim 11, wherein the electronic device is an power outlet, the power outlet comprising a plurality of receptacles, the power outlet powering at least a receptacles at the start time, and cutting-off the power supplied to the receptacles at the stop time.

14. A method for controlling device switching on/off, used for configuring on/off operation of an electronic using a mobile communication device, the method comprising:
providing a setting page on a haptic display unit of the mobile communication device, the setting page having a clock pattern and at least a set of timer indexes, the set of timer indexes including a switch-on index and a switch-off index, the switch-on index and the switch-off located on the fringe of the clock pattern indicating a start time and a stop time respectively;
determining the sliding operations of the switch-on index and switch-off index in response to the touch gestures of a user so as to determine the start time and stop time, wherein the start time and the start time vary along with positions of the switch-on index and the switch-off index;
switching on the electronic device in response to the start time determined; and
switching off the electronic device in response to the stop time determined.

15. The method according to claim 14, wherein the step after determining the start time and the stop time further comprises:
determining at least a date or a periodicity configured on a date/periodicity configuration area of the setting age according to the touch of the user;
wherein a processing unit switches on/off the electronic device in response to the start time and the stop time of the date or the periodicity configured.

16. The method according to claim 14, wherein the step after determining the start time and the stop time further comprises:
determining whether to select the start time corresponds to a switching-on index and the stop time corresponds to a switching-off index of another set of timer indexes; and
if another set of timer indexes is selected, returns to the steps of determining the sliding operations of the switch-on index and the switch-off index based on the touch gestures of the user.
